(19) United States
(12) Patent Application Publication
(10) Pub. No.: US 2002/0167617 A1
(43) Pub. Date: Nov. 14, 2002

(54) Closed loop television control system

(76) Inventor: Steven J. Vornsand, Lake In The Hills, IL (US)

Correspondence Address: Zenith Electronics Corporation, 2000 Millbrook Drive, Lincolnshire, IL, 60069, US

(21) Appl. No.: 09/852,883

(22) Filed: May 11, 2001

(51) Int. Cl. H04N 5/14; H04N 9/64

(52) U.S. Cl. 348/734; 348/571

(57) ABSTRACT

A television control system and method of controlling a television are disclosed. The system includes a host device in communication with one or more televisions. Each of the host devices and televisions use infrared transmitters and receivers. The host device, which may be provided in the form of a computer, receives inputs from a variety of devices, and generates command signals for transmission to each of the televisions. Each of the televisions receive the command signal, as by infrared transmission, and performs the commanded function. Once the commanded function is successfully performed, each of the televisions generates and transmits a confirmation signal to the host device to notify the host device, and ultimately the user, that the requested function has been performed.

### FIELD OF THE INVENTION

The invention generally relates to televisions and, more particularly, relates to television control systems.

### BACKGROUND OF THE INVENTION

Televisions can be controlled in a number of known fashions. For example, switches mounted to the console of the television can be manually depressed or actuated, with such actuation generating signals usable by a processor of the television to control or perform certain functions within the television.

Alternatively, remote control units can be employed wherein the function switches or buttons are provided on a unit separate from the television. The remote control unit employs a transmitter, typically an infrared transmitter, which transmits a signal generated upon actuation of the remote control unit to the television. The television includes a receiver, typically an infrared receiver, which receives the signal from the remote control unit and adjusts television functions accordingly.

In still further systems, one or more televisions can be controlled from a central host device. For example, in large facilities, such as in airports, office buildings, schools and the like, televisions or monitors positioned throughout the facility may need to be tuned to a single station or signal. The host device, which may be provided in the form of a personal computer, governs the channel to which the televisions are to be tuned and generates a command signal accordingly. Such signals may be transmitted via cabling or an infrared transmitter and receiver arrangement as discussed above.

However, the communication between the host device and the televisions is provided in only one direction. The host device has no apparatus by which to confirm that the request signal transmitted thereby was received, or that the function requested by the request signal has been successfully accomplished. Accordingly, if the host device subsequently transmits a second request signal to perform a function, which is conditioned upon successful completion of the first function, and the first function has not been successfully completed, the system will fail.

### SUMMARY OF THE INVENTION

In accordance with one aspect of the invention, a television control system is provided which comprises a host device and a television. The host device includes a transmitter and a receiver with the transmitter adapted to transmit a first signal. The television includes a transmitter and a receiver, with the receiver being adapted to receive the first signal and the transmitter being adapted to transmit a second signal receivable by the host device receiver.

In accordance with another aspect of the invention, a method of controlling the television is provided which comprises receiving a command signal from a host device, modifying television operation based on the command signal, and transmitting a confirmation signal from the television to the host device confirming the modification of the television operation.

In accordance with another aspect of the invention, a television control system is provided which comprises a remote control device, a host device, and at least one television. The remote control device has an input apparatus and a transmitter with actuation of the input apparatus causing the transmitter to transmit a request signal. The host device includes a processor, a receiver, and a transmitter. Receipt of the request signal by the host device receiver causes the processor to generate a command signal transmitted by the host device transmitter. The television includes a processor, a receiver, and a transmitter. Receipt of the command signal by the television receiver causes the television processor to perform a function. Performance of the function causes the television transmitter to transmit a confirmation signal receivable by the host device.

In accordance with another aspect of the invention, a television is provided which comprises a tuner adapted to receive a television broadcast signal, a monitor adapted to display television images based on the television broadcast signal, an input device adapted to generate a request signal, and a closed loop controller. The closed loop controller is adapted to receive a request signal, perform a television function based on the request signal, and transmit a confirmation signal when the television function is performed.

These and other aspects and features of the invention will become more apparent from the following detailed description when taken in conjunction with the accompanying drawings.

### BRIEF DESCRIPTION OF THE DRAWINGS

FIG. 1 is a schematic representation of a television system constructed in accordance with the teachings of the invention;

FIG. 2 is a schematic representation of a television control system constructed in accordance with the teachings of the invention;

FIG. 3 is a flow chart depicting sample steps which may be taken by a host device constructed in accordance with the teachings of the invention; and

FIG. 4 is a flow chart depicting sample steps which may be taken by a television constructed in accordance with the teachings of the invention.

While the invention is susceptible to various modifications and alternative constructions, certain illustrative embodiments thereof have been shown in the drawings and will be described below in detail. It should be understood, however, that there is no intention to limit the invention to the specific forms disclosed, but on the contrary, the intention is to cover all modifications, alternative constructions and equivalents falling within the spirit and scope of the invention as defined by the appended claims.

### DETAILED DESCRIPTION OF THE PREFERRED EMBODIMENTS

Referring now to the drawings and with specific reference to FIG. 1, a television system constructed in accordance with the teachings of the invention is generally referred to by reference numeral 20. As shown therein, the system 20 is adapted to control one or more televisions 22 from a single host device 24. Input signals or request signals are communicated to the host device 24, which then controls each of the televisions 22 in a similar fashion. The teachings of the invention provide a mechanism and process by which the host device 24 is ensured that the individual televisions 22 have successfully completed a function after it has been commanded to do so.

The host device 24 may be provided in a number of forms including a personal computer. The host device may also be part of a larger computer network within a given facility. The host device 24 may include a number of input devices 26. As shown in FIG. 1, the input devices 26 may include switches 28 provided directly on the host device. Alternatively, the switches 30 may be provided on one or more of the televisions 22. The input devices may also include one or more peripheral devices 32. The peripheral devices 32 may include a video cassette recorder 34, a digital video disc player 36, a computer or internet interface module 38, or the like. The host device 24 may also be connected to controls 40 normally not accessible to the user, such as automatic source switching, or external controls 42, such as a serial digital interface control. A remote control unit 44 may also be in communication with the host device 24. Alternatively, the host device 24 may be provided in the form of a remote control unit such as the remote control unit 44.

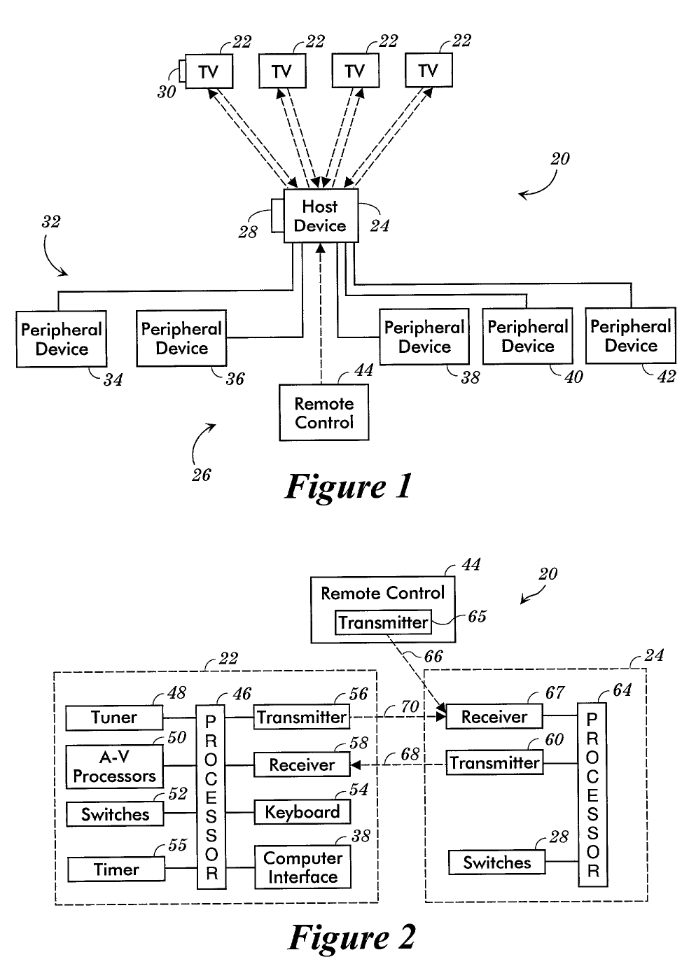

Referring now to FIG. 2, the host device 24 and the television 22 are shown in more detail. The television 22 is shown to include a processor 46 operatively connected to internal television devices such as the depicted tuner 48, video and audio processors 50, and switches 52. The processor 46 may also be connected to a keyboard 54 or other type of switch, and a timer 55, as well as the aforementioned computer interface 38. The television 22 further includes a signal transmitter 56 as well as a signal receiver 58 which both may utilize over the air signals such as sonic or infrared signals. Alternatively, hard wired systems may be used.

The host device 24 is shown in more detail in FIG. 2 to include a signal transmitter 60 and a signal receiver 62, which may utilize infrared signals, and a processor 64. The remote control unit 44 is also depicted to include a signal transmitter 65 adapted to utilize infrared signals.

Using such structure, the system 20 is able to not only receive input or request signals 66, such as those generated by the remote control unit 44, the switches 28, 30, or the peripheral devices 32, but also generate and transmit command signals 68 for control of each of the televisions 22. Furthermore, after the command signals 68 are successfully received by each of the televisions 22 and the television functions dictated by the command signal 68 are successfully accomplished, each of the televisions 22 is able to generate a confirmation signal 70. The host device 24 is therefore insured that a prior function has been successfully accomplished before it proceeds to command further functions to be performed.

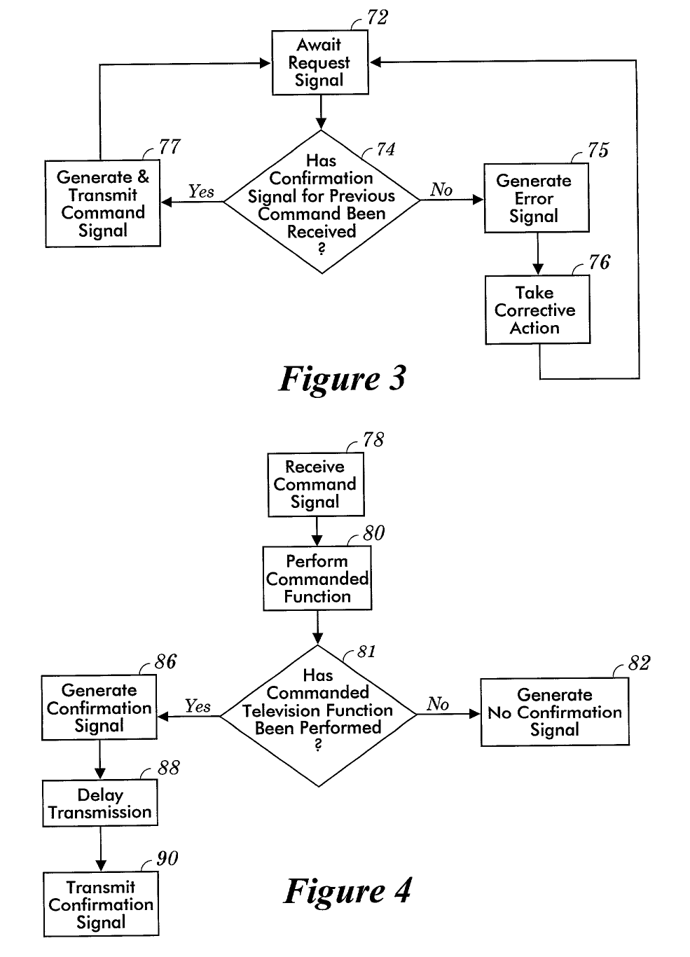

Referring now to FIGS. 3 and 4, the flow charts depicted therein illustrate a sample sequence of steps which may be performed by the host device 24 and television 22, respectively. Beginning with FIG. 3, the operator may begin the operation by the host device 24 receiving the request signal 66 as indicated by a step 72. Once the request signal 66 is received, the processor 64 of the host device 24 confirms whether the confirmation signal 70 has been received from each television 22 responsive to the previous request signal 66. This step is indicated by reference numeral 74. If the confirmation signals 70 have not been received, an error signal is generated in a stop 75. The generation of the error signal may be accomplished in a number of ways, including but not limited to, the generation of a warning displayed upon a screen of the host device 24, or the illumination of a LED or similar device on the host device 24. The error signal apprises the user of the situation, whereupon the user can take corrective action as indicated by a step 76.

If the confirmation signals 70 have been received, the host device processor 64 generates and transmits the command signal or signals 68 to each of the televisions 22 as indicated by a step 77. Each of the televisions 22 then attempts to perform the commanded television function, as illustrated, for example, in FIG. 4.

As shown therein, each television 22 may begin by receiving the command signal 68 as indicated by a step 78. The television 22 then attempts to perform the commanded function as indicated by a step 80. If the television 22 did not perform the commanded function as determined at a step 81, no confirmation signal is generated as indicated by a step 82. In this case, for example, the host 24 may resend the command or take other 20 appropriate action as indicated at step 76 of FIG. 4.

If the television 22 is able to successfully perform the television function commanded, the processor 46 of each of the televisions 22 generates the confirmation signals 70 as indicated by a step 86. Prior to transmitting the confirmation signal 70, however, each of the processors 46 delays transmission for a predetermined period of time, as indicated by a step 88. The predetermined period of time may be of any suitable length, preferably within the range of 100 to 500 milliseconds, but can be altered to any other suitable duration. The confirmation signal 70 is also preferably transmitted only a single time and is done so by modulating data onto a 40 KHz carrier wave, wherein the data signal is a 1200 baud, 8 bits byte, 1 start bit, 1 stop bit, no parity format packet. The packet preferably consists of three bytes including a command identifier byte, a data value byte, and a check sum byte which is the modulo 256 sum of the first two bytes.

After the delay step 88 has been performed, the processors 46 of the televisions 22 transmit the confirmation signals 70, as indicated by a step 90. The system 20 then returns to the step 72 to await the next request signal 66 to be entered into the system 20.

From the foregoing, one of ordinary skill in the art will appreciate that the system afforded by the teachings of the invention can be used to create a television or television control system or method of controlling a television which not only transmits signals from a host device to one or more televisions, but also provides a closed loop control system wherein each of the controlled televisions generates a confirmation signal once the demanded television function is successfully performed. In so doing, the host device is provided with confirmation that the requested and commanded function has been performed prior to subsequent requests being commanded.

What is claimed is:

1. A television control system, comprising:
a host device having a transmitter and a receiver, the host device transmitter adapted to transmit a first signal; and
a television having a transmitter and a receiver, the television receiver adapted to receive the first signal, the television transmitter adapted to transmit a second signal receivable by the host device receiver.

2. The television control system of claim 1, wherein the host device and television transmitters and receivers are infrared devices.

3. The television control system of claim 1, wherein the host device is a personal computer.

4. The television control system of claim 1, wherein the host device is a television remote control unit.

5. The television control system of claim 1, wherein the first signal is a command signal instructing the television to perform a function, and wherein the second signal is a confirmation signal confirming that the television performed the function.

6. The television control system of claim 5, wherein the television further includes a processor and a timer, the processor directing the command signal to be transmitted within about 100 milliseconds to about 500 milliseconds after the function is performed.

7. The television control system of claim 1, wherein the second signal is a 1200 baud, 8 bits byte, 1 start bit, 1 stop bit, no parity format packet modulated onto a 40 KHz carrier wave.

8. The television control system of claim 7, wherein the packet includes a command identifier byte, a data value byte, and a check sum byte.

9. The television control system of claim 1, wherein the host device further includes a processor adapted to control at least one peripheral device.

10. The television control system of claim 9, wherein the peripheral device is a video cassette recorder.

11. The television control system of claim 9, wherein the peripheral device is a digital video disc player.

12. The television control device of claim 1, wherein the host device further includes an input device.

13. The television control device of claim 12, wherein input device is a keyboard.

14. The television control device of claim 12, wherein input device is at least one switch provided on a television console.

15. The television control device of claim 12, wherein input device employs a computer protocol.

16. A method of controlling a television, comprising the steps of:
receiving a command signal from a host device;
modifying television operation based on the command signal; and
transmitting a signal from the television to the host device confirming the modification of the television operation.

17. The method of claim 16, wherein the transmission of the confirmation signal is performed between about 100 milliseconds and about 500 milliseconds after the modification of the television operation.

18. The method of claim 16, wherein the confirmation signal and the command signal comprise infrared signals.

19. A television control system, comprising:
a remote control device having an input apparatus and a transmitter, actuation of the input apparatus causing the transmitter to transmit a request signal;
a host device having a processor, a receiver, and a transmitter, receipt of the request signal by the host device receiver causing the processor to generate a command signal transmitted by the host device transmitter; and
at least one television having a processor, a receiver, and a transmitter, receipt of the command signal by the television receiver causing the television processor to perform a function, performance of the function causing the television transmitter to transmit a confirmation signal receivable by the host device.

20. The television control system of claim 19, further including a plurality of televisions each having a processor, receiver and transmitter, each television receiver receiving the command signal and each transmitter transmitting a confirmation signal upon performance of the function.

21. The television control system of claim 19, wherein the request, command, and confirmation signals are infrared signals.

22. The television control system of claim 19, further including at least one peripheral device generating a request signal, the host device being responsive to the request signal.

23. The television control system of claim 22, wherein the peripheral device is a video cassette recorder.

24. The television control system of claim 22, wherein the peripheral device is a digital video disc player.

25. A television, comprising:
a tuner adapted to receive a television broadcast signal;
a monitor adapted to display television images based on the television broadcast signal;
an input device adapted to generate a request signal; and
a closed loop controller, the closed loop controller adapted to receive the request signal, perform a television function based on the request signal, and transmit a confirmation signal when the television function is performed.

26. The television of claim 25, wherein the closed loop controller prevents performance of further television functions until the confirmation signal for an immediately prior television function is successfully performed.

27. The television of claim 25, wherein the request and confirmation signals are infrared signals and wherein the closed loop control system includes an infrared receiver, a processor, and an infrared transmitter, the infrared receiver receiving the request signal, the infrared transmitter transmitting the confirmation signal.

28. The television of claim 25, wherein the input device is a switch mounted to the television.

29. The television of claim 25, wherein the input device is a remote control unit.

30. The television of claim 25, wherein the input device is a host computer.
